(19) United States
(12) Patent Application Publication
(10) Pub. No.: US 2014/0345186 A1
(43) Pub. Date: Nov. 27, 2014

(54) STORAGE CHAMBER FOR TARGETING FISH

(71) Applicant: Tim Tarver, Glennville, GA (US)

(72) Inventor: Tim Tarver, Glennville, GA (US)

(21) Appl. No.: 14/282,504

(22) Filed: May 20, 2014

Related U.S. Application Data
(60) Provisional application No. 61/825,892, filed on May 21, 2013.

(51) Int. Cl. A01K 97/05

(52) U.S. Cl. CPC A01K 97/05
USPC 43/44.99

(57) ABSTRACT

Implementations of the storage chamber for targeting fish of the present disclosure are configured to store and protect baited hooks on a fishing line under water until a desired time (e.g., presentation to a target fish species). In some implementations, the storage chamber of the present disclosure may be configured to store multiple baited hooks and configured to release the baited hooks individually, for example, at different desired times. In this way, the storage chamber may be used multiple times before retrieving the storage chamber from the water to supply it with additional baited hooks. Furthermore, in some implementations, the storage chamber of the present invention can serve as a bait protector and fish attractor.

### CROSS REFERENCE TO RELATED APPLICATION

This application claims the benefit of U.S. Patent Application Ser. No. 61/825,892, which is incorporated herein by reference in its entirety.

### TECHNICAL FIELD

This disclosure relates to implementations and methods of using a storage chamber for targeting fish.

### BACKGROUND

It can be difficult to catch a target fish species in the presence of non-target fish species (e.g., undesired, protected, threatened, or endangered species). For example, if non-target fish species typically reside at a depth above a target fish species, the non-target fish species may remove the bait from hooks or interfere with the bait before the baited hook reaches the target fish species.

U.S. Pat. Nos. 5,131,183 and 5,943,810 disclose existing bait protectors to protect bait until the bait is in the vicinity of a target fish species. However, these bait protectors can only be used once. That is, once the bait is released from the bait protector, the bait protector must be retrieved from the water after a single use. More specifically, to release the bait from the bait protector, the bait protectors of the prior art are disassembled and the bait protectors first must be retrieved from the water and re-assembled before they can be used again. Thus, these existing bait protectors do not allow for multiple uses of the bait protector to release one or more baited hooks at different times without having to retrieve the bait protector from the water to supply the bait protector with additional baited hooks. Still further, existing bait protectors do not serve as both a bait protector and fish attractor

### BRIEF DESCRIPTION OF THE DRAWINGS

FIGS. 1A and 1B illustrate a first example storage chamber for targeting fish according to the present disclosure.

FIG. 2 illustrates a second example storage chamber for targeting fish according to the present disclosure.

FIGS. 3 illustrates a third example storage chamber for targeting fish according to the present disclosure.

### DETAILED DESCRIPTION

Implementations of the storage chamber for targeting fish of the present disclosure are configured to store and protect baited hooks on a fishing line under water until a desired time (e.g., presentation to a target fish species). In some implementations, the storage chamber of the present disclosure may be configured to store multiple baited hooks and configured to release the baited hooks individually, for example, at different desired times. In this way, the storage chamber may be used multiple times before retrieving the storage chamber from the water to supply it with additional baited hooks. Furthermore, in some implementations, the storage chamber of the present invention can serve as a bait protector and fish attractor.

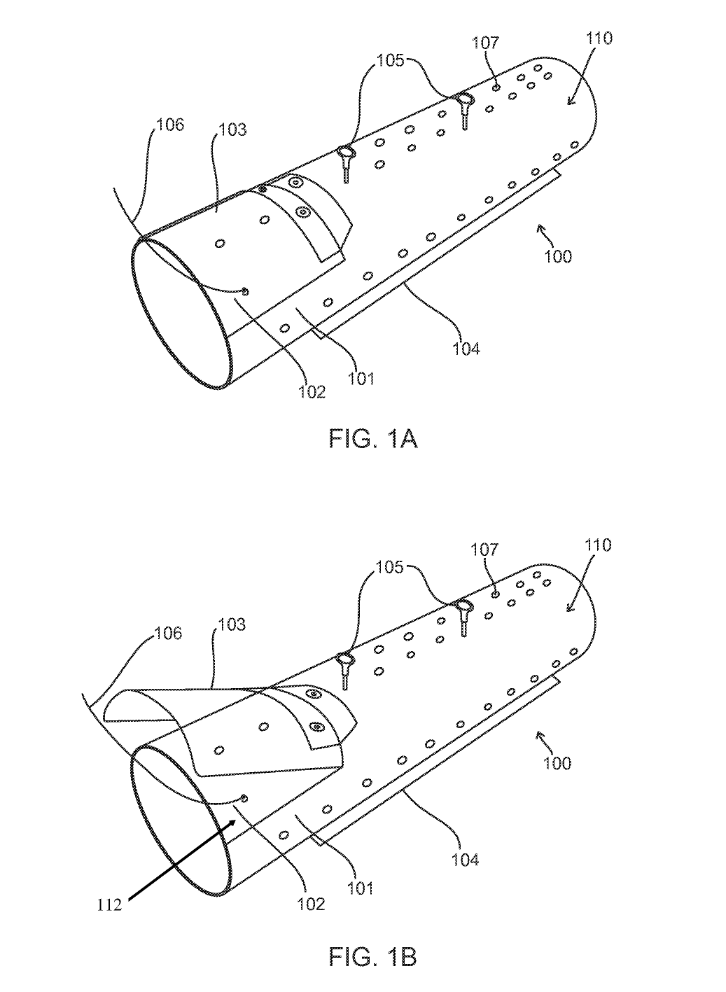

FIG. 1A and 1B illustrates an example implementation of a storage chamber 100 for targeting fish according to the principles of the present disclosure.

In some implementations, the storage chamber 100 comprises a housing 101 having holes 107 therethrough and an interior storage compartment 110 that may be accessed through a covered opening 102. In some implementations, the covered opening 102 may be comprised of an opening 112 into the housing 101 and a closure 103 (e.g., a lid). In some implementations, the covered opening 102 may be configured to secure one or more baited hooks on a fishing line 106 in the interior storage compartment 110 under water until a desired time (e.g., presentation to a target fish species). In some implementations, the storage chamber 100 may further comprise an attachment mechanism 105 for lowering or lifting the storage chamber 100.

In some implementations, the housing 101 may be a cylinder (see, e.g., FIG. 1A). In some implementations, the housing may be a rectangle. In some implementations, the housing 101 may be any suitable shape.

In some implementations, the holes 107 may be of sufficient size to, for example, aerate live baits and distribute the scent of the contents of the storage chamber 100. In some implementations, the holes 107 may be of sufficient size to restrict the exit of any content in the interior storage compartment 110 of the storage chamber 100. In this way, non-hooked bait or other aquatic attractant material may be added to the storage chamber 100. In some implementations, the holes 107 may be circular. In some implementations, the holes 107 may be any suitable shape.

In some implementations, the covered opening 102 may be configured to release the one or more baited hooks from the interior storage compartment 110 of the storage chamber 100. In some implementations, the covered opening 102 may be configured to open from a pull on a fishing line of a baited hook stored in the storage chamber 100 to release the baited hook from the storage chamber 100. In some implementations, the storage chamber 100 may include one or more covered openings 102. In some implementations, the one or more covered openings 102 may be located on each end of the storage chamber 100.

In some implementations, the closure 103 may be configured to automatically cover the opening 112 after the one or more baited hooks have cleared the covered opening 102. In some implementations, the closure 103 may include a hinge.

In some implementations, the storage chamber 100 may further comprise a weight 104 attached under the storage chamber 100 to, for example, maintain the storage chamber 100 in an upright position when submerged in water.

In some implementations, the attachment mechanism 105 (e.g., a ring) may be used to attach the storage chamber 100 to a lowering and lifting device (e.g., a downrigger). In some implementations, the attachment mechanism 105 may be attached to the storage chamber 100 using the holes 107. In some implementations, the storage chamber 100 may include one or more attachment mechanisms (e.g., rings or any other appropriated device) to attach the storage chamber to a lowering and lifting device (e.g., a downrigger).

In some implementations, to use the storage chamber 100 for targeting fish, at least a portion of a fishing line 106 having a baited hook may be placed into the interior storage compartment 100 of the housing 101 through the covered opening 102. The storage chamber 100 then may be lowered into the water. In some implementations, the storage chamber 100 may be lowered into the water through the use of a downrigger (or similar device suitable for lowering the storage chamber 100) secured to the attachment mechanism 105 of the housing 101. Once the storage chamber 100 has reached a target zone, a user may pull on the fishing line 106 connected to the at least one baited hook, thereby freeing the baited hook and line from the storage chamber 100.

In some implementations, more than one fishing line 106 may be used at a given time. In some implementations, more than one hook may be used with each fishing line 106.

In some implementations, non-hooked bait or other aquatic attractant material may be placed within the interior storage compartment 110 of the storage chamber 100 prior to submersion in the water. In this way, a target species of fish or other aquatic wildlife may be attracted to the vicinity of the storage chamber 100.

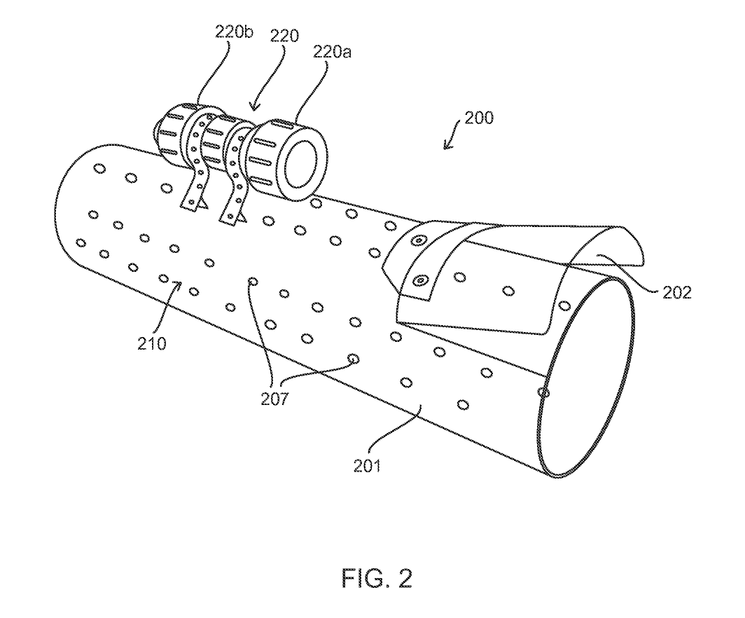

FIG. 2 illustrates another implementation of a storage chamber 200 according to the present disclosure. In some implementations, the storage chamber 200 may include one or more features of storage chamber 100 (e.g. the housing 201, covered opening 202, holes 207) and further includes one or more cameras 220 mounted on top of the storage chamber 200. In some implementation, two cameras 220a, 220b may be facing opposite directions. In this way, the cameras 220 may capture images of events transpiring at and/or around both ends of the storage chamber to determine the right time to release a baited hook. In some implementations, the storage container 200 may include more than two cameras. In some implementations, the one or more cameras 220 may be mounted using the holes 207 in the housing 201 of the storage chamber 200.

In some implementations, the one or more cameras 220 of the storage container 200 may be connected to a recording device. In this way, images and/or video footage captured by a camera 220 may be stored for later use and/or distribution.

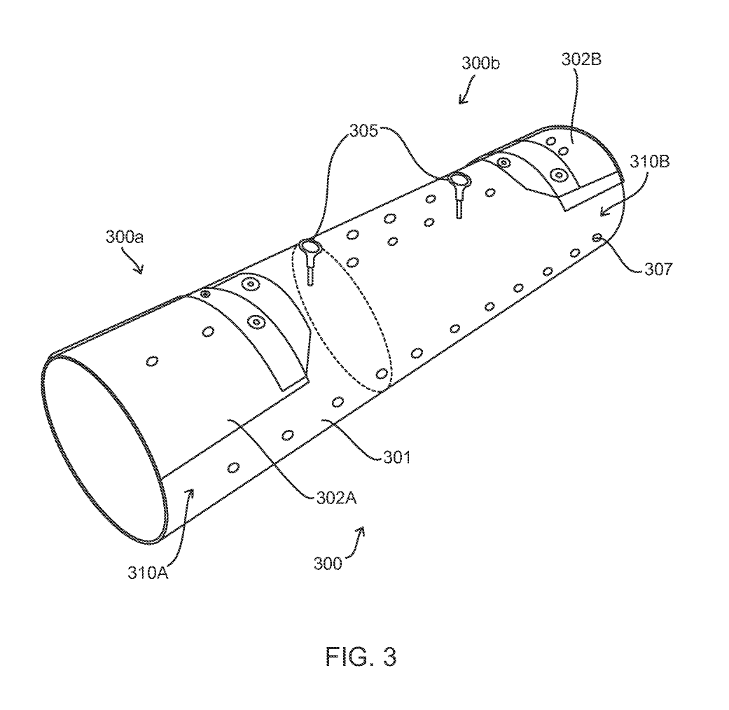

FIG. 3 illustrates another implementation of a storage chamber 300 according to the present disclosure. In some implementations, the storage chamber 300 comprises two storage chambers 300a, 300b connected end to end. Each storage chamber 300a, 300b may include one or more features of storage chamber 100 (e.g. the housing 301, covered openings 302a, 302b, holes 307, attachment mechanism 305) and/or 200 (e.g., the camera(s) 220 and/or recording devices) and have an interior storage compartments 310A, 310B, respectively, that may be accessed through covered openings 302A, 302B, respectively.

In some implementations, one compartment may be used to store live bait and another compartment may be used to store dead bait. In some implementations, one compartment may be used to store a first bait-type and another compartment may be used to store a second bait-type.

In some implementations, the interior storage compartments 310A, 310B may be created by placing a wall within the interior of the storage container 100. In this way, the contents of the interior storage compartments may be kept separated.

In some implementations, a remote controlled propulsion device can be attached to a storage chamber 100, 200, 300 constructed in accordance with the present disclosure.

In some implementations, a spear gun may be mounted to a storage chamber 100, 200, 300 constructed in accordance with the present disclosure.

In some implementations, a storage chamber 100, 200, 300 may be clear and/or translucent. In some implementations, a storage chamber 100, 200, 300 may be semi-transparent. In some implementations, a storage chamber 100, 200, 300 may be any color suitable for fishing and/or attracting aquatic life.

In some implementations, a storage chamber 100, 200, 300 may be manufactured from corrosion resistant materials. In some implementations, the storage chamber 100, 200, 300 may be manufactured from any material suitable for use in a marine environment.

In some implementations, a storage container constructed according to the present disclosure may include a depth control gauge. In this way, a user may be better able to place the storage container at a depth which is ideal for the target fish species. In some implementations, the depth control gauge can be positioned on the storage container in a manner that allows it to be monitored by a camera.

In some implementations, a global positioning satellite (GPS) device may be secured to a storage container constructed according to the present disclosure. In this way, a user may be able to either find or avoid specific locations which may or may not be desirable for attracting the target fish species. In some implementations, the GPS device can be positioned on the storage container in a manner that allows it to be monitored by a camera.

In some implementations, the storage container may include a thermometer. In this way, a user may know the water temperature. In some implementations, the thermometer can be positioned on the storage container in a manner that allows it to be monitored by a camera.

Reference throughout this specification to “an embodiment” or “an implementation” or words of similar import means that a particular described feature, structure, or characteristic is included in at least one embodiment of the present invention. Thus, the phrase “in an embodiment” or “an implementation” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A storage chamber for targeting fish comprising:
a housing having a plurality of first holes and at least one opening configured to access an interior storage compartment to place bait, wherein the plurality of first holes are smaller in size than the at least one opening; and
a lid configured to cover the at least one opening in a first position to secure bait within the interior storage compartment and configured to expose the at least one opening in a second position to release the bait from the interior storage compartment wherein the housing and lid are configured to be fixedly connected during the opening and closing of the lid during bait release.

2. The storage chamber of claim 1 wherein the housing comprises two openings configured to access the interior storage compartment, one opening is located on each end of the housing.

3. The storage chamber of claim 2 the housing further comprises a wall located within the interior storage compartment to divide the interior storage compartment into two separate portions.

4. The storage chamber of claim 1 further comprising a weight secured to a bottom side of the housing.

5. The storage chamber of claim 1 further comprising at least one camera, wherein the at least one camera is mounted using the plurality of first holes in the housing.

6. The storage chamber of claim 5 is further comprised of a first camera and a second camera, wherein the first camera is facing in a first direction and the second camera is facing in a second direction.

7. The storage chamber of claim 1 further comprising at least one attachment mechanism, wherein the at least one attachment mechanism is mounted using the plurality of first holes in the housing.

8. The storage chamber of claim 1 further comprising a hinge that operably connects the lid to the housing.

9. The storage chamber of claim 1 wherein the housing is a cylinder.

10. The storage chamber of claim 1 wherein the plurality of first holes are aeration holes.

11. A method of using the storage chamber for targeting fish of claim 1, the method comprising:
moving the lid to the first position and inserting a portion of at least one fishing line having a baited hook secured thereto into the interior storage compartment of the housing through the at least one opening and;
moving the lid to the second position to cover the at least one opening to secure the at least one fishing line having a baited hook within the interior storage compartment;
submerging the storage chamber into a body of water; and
pulling on the fishing line until the baited hook is released from the interior storage compartment.

12. The method of claim 10 further comprises placing non-hooked bait into the interior storage compartment of the housing.

13. The method of claim 10 further comprises placing aquatic attractant material into the interior storage compartment of the housing.
